(19) United States
(12) Patent Application Publication
(10) Pub. No.: US 2019/0163790 A1
(43) Pub. Date: May 30, 2019

(54) SYSTEM AND METHOD FOR GENERATING AGGREGATED STATISTICS OVER SETS OF USER DATA WHILE ENFORCING DATA GOVERNANCE POLICY

(71) Applicant: Intuit Inc., Mountain View, CA (US)

(72) Inventors: James Jennings, San Diego, CA (US); Yao H. Morin, San Diego, CA (US); Mustafa Iqbal, San Diego, CA (US); Deepen Prashant Mehta, San Diego, CA (US); Ralph Tice, San Diego, CA (US); Ravindra Kulkarni, San Diego, CA (US); Ganesh Kannappan, Bangalore (IN)

(73) Assignee: Intuit Inc., Mountain View, CA (US)

(21) Appl. No.: 15/825,832

(22) Filed: Nov. 29, 2017

(51) Int. Cl. G06F 17/30; G06F 21/62; G06N 99/00

(52) U.S. Cl. CPC G06F 17/30516; G06N 99/005; G06F 17/30554; G06F 21/6218

(57) ABSTRACT

A system and method for use with a data management service provides aggregated statistics derived from a large amount of user data extracted from one or more transaction management systems. The aggregated statistics are based on client queries from client systems. The queries request statistical information about a queried user grouping. An input interpreter module uses machine learning to modify the queried user grouping into a plurality of improved user groupings. A statistics calculator module performs a set of calculations on the user data based on the improved user groupings, and returns the results to an output preparer module. The output preparer module uses machine learning to determine which aggregated statistic to return to the client system.

### BACKGROUND

Data management service providers capture large amounts of data, and use this data to make competitive business decisions, streamline business processes, and improve customers' experiences. The amount of data that is captured by data management service providers is so vast that it is difficult, if not impossible, for the human mind to envision the volume of data gathered. Data may come from a variety of sources, such as various transaction management systems provided by the data management service providers. Large numbers of users of the various transaction management systems are constantly creating new data with what seems to be ever increasing and more extreme velocity every day. Furthermore, the data coming from different transaction management systems may contain inconsistencies, requiring data management service providers to assess the veracity of the large quantities of data, such as ensuring data conforms to proscribed formats, reconciling discrepancies between data from different sources, and evaluating different data sources.

Data management service providers glean key insights from the large amounts of data through data analytics. Data analytics allow for data exploration and visualization, which can provide competitive advantages through human-comprehensible stories expressed using data analytics. Actionable insights can be gained by asking the right questions through queries. The queries enable the derivation of relevant variables and datasets to generate hypothesis formulations and conclusion testing. Such data analytics can typically only be achieved through a substantial investment in hardware architecture and qualified personnel.

While data management service providers have much to gain from the analysis of large amounts of data, the providers must ensure that privacy and security concerns are addressed. Many countries have privacy laws mandating the protection of confidential information. Furthermore, data management service providers are expected to maintain security measures over user data. In addition, many data owners may expect that and governments may mandate that data management service providers use data in an ethical way based on what can and cannot be done with the data. Such data privacy and security concerns are addressed by data management service providers through data governance policies.

One consequence of these privacy and security concerns is that they have created barriers to making data publicly available. Current data management service provider environments provide information to users based solely on each user's data in isolation from other users' data. While crowdsourced data is often considered useful in its provision of more accurate and thorough insights into data of similar users, crowdsourced data is nevertheless traditionally limited due to privacy concerns, security concerns, regulations, and the like. Consequently, what is needed is a system and method that solves the long standing technical problem in the data management arts of the inability to provide clients with aggregated statistics of users' data from electronic transaction management systems while still enforcing data governance policy and ensuring security and privacy concerns are properly addressed.

### SUMMARY

Embodiments of the present disclosure provide technical solutions that address some of the shortcomings associated with traditional data management service provider systems by providing systems and methods to generate aggregated statistics over groups of users from user data while simultaneously ensuring that data governance policy over the aggregated statistics is upheld and enforced. Embodiments of the present disclosure accomplish this by extracting user data from various data warehouses. In various embodiments, a data warehouse is a data store for analysis of historical data derived from transaction data. In various embodiments, a data warehouse is a central repository of consolidated data from several sources of transaction data. Each data warehouse may be associated with a transaction management system that generated the user data from user systems and financial institution systems interacting with the transaction management systems. In one embodiment, a data pipeline module extracts the user data from the data warehouses and stores it as pipeline data into a pipeline database of an aggregated statistics system. The user data is thus made available within the aggregated statistics system for production on a runtime basis.

Embodiments of the present disclosure provide a system and method for generating aggregated statistics over sets of user data while enforcing data governance policy. In one embodiment, a client interface module interfaces with client systems to receive client queries about information that a client is seeking. In one embodiment, an input interpreter module utilizes machine learning and artificial intelligence to translate the client query into one or more calculations on one or more data sets based on determined user groupings. In one embodiment, a statistics calculator module calculates the aggregated statistics over the user data based on instructions received from the input interpreter module.

In one embodiment, the statistics calculator module provides an output preparer module with the one or more aggregated statistics calculated by the statistics calculator module. In one embodiment, the output preparer module utilizes machine learning and artificial intelligence to analyze the one or more aggregated statistics to select the aggregated statistic to return to the client system. In one embodiment, the output preparer module provides the query result to the client interface module, which transmits the query result to the client system from which the client query had been received. In one embodiment, the output preparer module enforces data governance policy, such as by restricting the query result that may be transmitted to a client system.

### BRIEF DESCRIPTION OF THE DRAWINGS

FIG. 1 is a functional block diagram of a production environment for aggregated statistics generation over sets of user data while enforcing data governance policy, in accordance with various embodiments.

FIG. 2 is a functional block diagram of a production environment for aggregated statistics generation over sets of user data while enforcing data governance policy, in accordance with various embodiments.

FIG. 3 is a flow diagram of a process for aggregated statistics generation over sets of user data while enforcing data governance policy, in accordance with various embodiments.

FIG. 4 is a diagram of examples of portions of illustrative data for aggregated statistics generation over sets of user data while enforcing data governance policy, in accordance with various embodiments.

FIG. 5 is a diagram of examples of portions of illustrative data for aggregated statistics generation over sets of user data while enforcing data governance policy, in accordance with various embodiments.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying figures, which depict one or more exemplary embodiments. Embodiments may be implemented in many different forms and should not be construed as limited to the embodiments set forth herein, shown in the figures, and/or described below. Rather, these exemplary embodiments are provided to allow a complete disclosure that conveys the principles of the invention, as set forth in the claims, to those of skill in the art.

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system,” “computing device,” and “computing entity,” include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application. In various embodiments, one or more cloud computing environments are used to create, and/or deploy, and/or operate an application that can be any form of cloud computing environment, such as, but not limited to, a public cloud; a private cloud; a Virtual Private Cloud (VPC); or any other cloud-based infrastructure, sub-structure, or architecture, as discussed herein, and/or as known in the art at the time of filing, and/or as developed after the time of filing. In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing. In various embodiments, any, or all, of the assets making up a given production environment discussed herein, and/or as known in the art at the time of filing, and/or as developed after the time of filing, can be implemented as one or more virtual assets.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, communication channel, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the terms “user,” “client,” and “customer” include, but are not limited to, any party, parties, entity, or entities using, or otherwise interacting with any of the methods or systems discussed herein. For instance, in various embodiments, a user can be, but is not limited to, a person, a commercial entity, an application, a service, or a computing system.

As used herein, the term “relationship” includes, but is not limited to, a logical, mathematical, statistical, or other association between one set or group of information, data, and/or users and another set or group of information, data, and/or users, according to one embodiment. The logical, mathematical, statistical, or other association (i.e., relationship) between the sets or groups can have various ratios or correlation, such as, but not limited to, one-to-one, multiple-to-one, one-to-multiple, multiple-to-multiple, and the like, according to one embodiment. As a non-limiting example, if the disclosed system and method for providing access control and enhanced encryption determines a relationship between a first group of data and a second group of data, then a characteristic or subset of a first group of data can be related to, associated with, and/or correspond to one or more characteristics or subsets of the second group of data, or vice-versa, according to one embodiment. Therefore, relationships may represent one or more subsets of the second group of data that are associated with one or more subsets of the first group of data, according to one embodiment. In one embodiment, the relationship between two sets or groups of data includes, but is not limited to similarities, differences, and correlations between the sets or groups of data.

As used herein, the terms “data store,” “data storage device,” and “data warehouse” include, but are not limited to, any physical or virtual data source or storage device. For instance, in various embodiments, a data store or storage container can be, but is not limited to, one or more of a hard disk drive, a solid-state drive, an EEPROM, an optical disk, a server, a memory array, a database, a virtual database, a virtual memory, a virtual data directory, a non-transitory computer-readable medium, or other physical or virtual data sources.

As used herein, the term “conduit” includes, but is not limited to, the flow of data and information from one or more system modules, process operations, and the like to another one or more system modules and process operations, and the like. A conduit may be a physical implementation, a virtual implementation, and the like.

As used herein, the terms “artificial intelligence,” “machine learning,” and “machine learning algorithms” include, but are not limited to, machine learning algorithms for predictive model training operations such as one or more of artificial intelligence operations, regression, logistic regression, decision trees, artificial neural networks, support vector machines, linear regression, nearest neighbor methods, distance based methods, naive Bayes, linear discriminant analysis, k-nearest neighbor algorithm, another query classifier, and any other presently known or later developed predictive model training operations, according to one embodiment.

As used herein, the term “system” includes, but is not limited to, the following: computing system implemented, and/or online, and/or web-based, personal and/or business transaction aggregation and/or processing systems, services, packages, programs, modules, or applications; computing system implemented, and/or online, and/or web-based, personal and/or business data management systems, services, packages, programs, modules, or applications; computing system implemented, and/or various other personal and/or business electronic data management systems, services, packages, programs, modules, or applications, whether known at the time of filing, or as developed later.

As used herein, the term “transaction management system” includes, but is not limited to, the following: computing system implemented, and/or online, and/or web-based, personal and/or business transaction management systems, services, packages, programs, modules, or applications; computing system implemented, and/or online, and/or web-based, personal and/or business tax preparation systems, services, packages, programs, modules, or applications; computing system implemented, and/or online, and/or web-based, personal and/or business accounting and/or invoicing systems, services, packages, programs, modules, or applications; and various other personal and/or business electronic data management systems, services, packages, programs, modules, or applications, whether known at the time of filling or as developed later.

As used herein, a transaction management system can be, but is not limited to, any data management system implemented on a computing system, accessed through one or more servers, accessed through a network, accessed through a cloud, and/or provided through any system or by any means, as discussed herein, and/or as known in the art at the time of filing, and/or as developed after the time of filing, that gathers financial data, including financial transactional data, from one or more sources and/or has the capability to analyze and categorize at least part of the financial data.

Specific examples of transaction management systems include, but are not limited to the following: QuickBooks™, available from Intuit, Inc. of Mountain View, Calif.; QuickBooks On-line™, available from Intuit, Inc. of Mountain View, Calif.; QuickBooks Self-Employed available from Intuit, Inc. of Mountain View, Calif.; Mint On-Line™, available from Intuit, Inc. of Mountain View, Calif.; Mint On-Line™, available from Intuit, Inc. of Mountain View, Calif.; TurboTax™, available from Intuit, Inc. of Mountain View, Calif., and/or various other transaction management systems discussed herein, and/or known to those of skill in the art at the time of filing, and/or as developed after the time of filing.

As used herein, the term “transaction” includes, but is not limited to, any operation through which ownership or control of any item or right is transferred from one party to another party. One specific illustrative example of a transaction is a financial transaction.

Embodiments of the present disclosure provide a system and method for use with a data management service that provides for the generation of aggregated statistics over sets of user data while enforcing data governance policy. In various embodiments, the aggregated statistics are based on client queries from client systems. The queries request statistical information via a client interface module about a queried user grouping. An input interpreter module uses machine learning and artificial intelligence to modify the queried user grouping into a plurality of improved user groupings. A statistics calculator module performs a set of calculations on the user data based on the improved user groupings, and returns the results to an output preparer module. The output preparer module uses machine learning and artificial intelligence to determine which aggregated statistic to return to the client system via the client interface module.

The disclosed embodiments provide one or more technical solutions to the technical problem of generating aggregated statistics over grouping profiled sets of user data while simultaneously ensuring that data governance policy for the aggregated statistics is upheld and enforced. These and other embodiments of a data management system are discussed in further detail below.

It is to be appreciated that the disclosed embodiments address some of the shortcomings of a data management system under current data management processing environments. For example, under a current data management system, clients of a data management system are not permitted to perform analytics on other users' data due to data governance policy concerns. Historically, analytics of user data of a data management system was restricted to personnel who were entrusted to keep such data confidential.

### Overview

Data management service providers frequently store great quantities of data that is considered useful for analysis, decision-making, insight discovery, and the like. Such useful data is typically guarded painstakingly by a data management service provider, at least because most users do not want their data publicly published or available through non-consensual means. Accordingly, current data management service providers limit access to its data, such as by providing access only to personnel for internal purposes, for example, to improve a service provider's marketing campaigns and other similar internal uses.

Embodiments of the present disclosure provide a system and method for use with a data management service that provides for the generation of aggregated statistics over sets of user data while enforcing data governance policy. Embodiments of the present disclosure allow a service provider to expose its data to clients in the form of aggregated statistics while maintaining the confidentiality standards for individual user data held by the service provider. In one embodiment, a service provider possesses a large amount of data, big data, and the like. In one embodiment, the data of the service provider may include personal finance data, tax data, small business data, social media data, and the like.

Embodiments of the present disclosure take advantage not only of the quantity of data, but also the quality of data of the service provider, and expose such useful data externally, for example, through statistical analysis of the data. The results of a statistical analysis can be provided externally to clients through client systems, such as an application developed by the service provider, as well as an application developed by a third party. Embodiments of the present disclosure allow for the querying for aggregated statistics about groups of users defined for a service provider's data, while simultaneously ensuring a service provider's security and data governance policies are upheld. In one embodiment, a service provider's data is stored outside of the system, such as in a data warehouse. In one embodiment, the data may be imported into the system and clients may query such data for aggregated statistics.

In one embodiment, an aggregated statistic is a measure of some attribute of a data sample, in which the measure may be a minimum, a maximum, a mean, a median, a count, a percentile, a standard deviation, a percentage breakdown, and the like. An aggregated statistic can be calculated by applying a statistical algorithm to values of items of a data sample, which may be known as a set of data within the system. For example, an aggregated statistic may be an average credit score, average income, and the like. In one embodiment, a client system has a client interface that allows clients to define the aggregated statistic that the client wishes to receive. For example, a client system may allow a client to query for average credit score, average income, and the like. In one embodiment, the allowable statistical functions that a client can request may be restricted based, for example, on data privacy concerns.

In one embodiment, a client may query for an aggregated statistic based on a grouping of users. For example, a client may define a data set as people within a certain age range, who live within a certain geographic location, who have a certain occupation, and who have a certain income range. In one embodiment, a threshold number of data points is required to be reached in order to prevent a query from being so excessively narrow that a client can deduce information about one or more users that fit within a query. For example, if a client knew of a user who was the only individual in a certain profession in a small town, the system would not permit the results of such a query to be returned to the client. Such prevents a client who knows a little bit about a user from learning more about that specific individual user. Accordingly, a client is unable to determine an individual user's credit score, debt level, and the like.

In one embodiment, system access rules and data distribution rules are applied to aggregated statistics before being returned to a client. In one embodiment, access controls are utilized to ensure security measures are enforced, such as, ensuring that permissions are adequately received, connections are proper on a network, and the like. For example, data infiltration may be blocked to prevent the ability to extract data sets from the system. In one embodiment, privacy controls are utilized to prevent individual user data from being exposed to people other than that user. For example, differential attacks may be blocked to prevent a violation of statistical anonymity. Accordingly, clients are able to make use of the large amount of data of the service provider without exposing confidential information about users of the service provider's system.

### Hardware Architecture

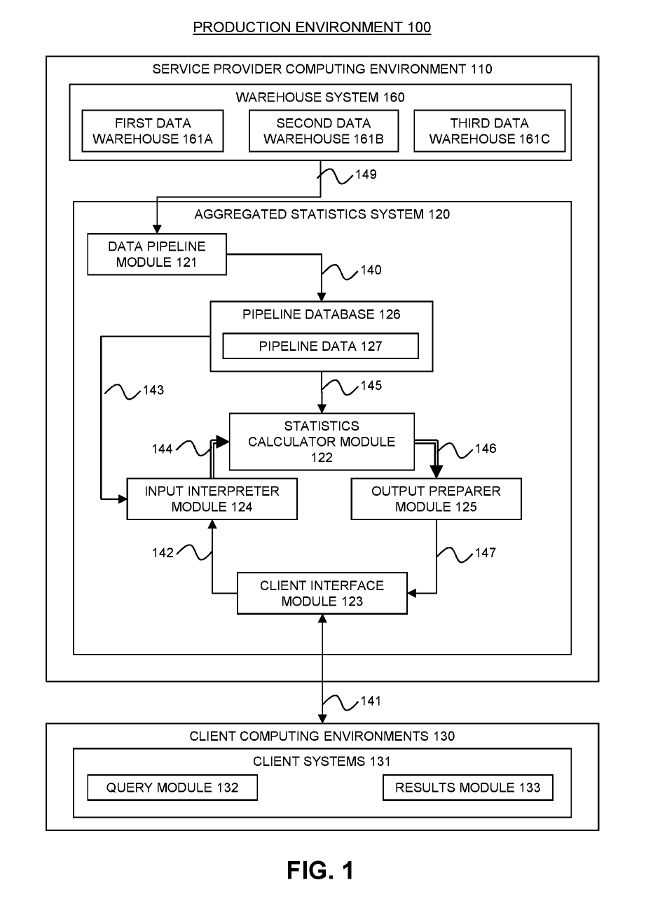

FIG. 1 is a functional block diagram of a production environment 100 for aggregated statistics generation over sets of user data while enforcing data governance policy, in accordance with various embodiments. The production environment 100 includes a service provider computing environment 110 and client computing environments 130, for generating aggregated statistics over sets of user data while enforcing data governance policy, according to various embodiments. The computing environments 110 and 130 are communicatively coupled to each other with one or more communication channels 141, according to various embodiments. Communication channels 141 may include one or more physical or virtual networks.

The service provider computing environment 110 represents one or more computing systems such as one or more servers and/or distribution centers that are configured to receive, execute, and host one or more data management systems (e.g., applications) for access by one or more clients, for generating aggregated statistics over sets of user data while enforcing data governance policy, according to one embodiment. The service provider computing environment 110 represents a traditional data center computing environment, a virtual asset computing environment (e.g., a cloud computing environment), or a hybrid between a traditional data center computing environment and a virtual asset computing environment, according to various embodiments.

The service provider computing environment 110 includes a warehouse system 160 and an aggregated statistics system 120. The warehouse system 160 may include a collection of data warehouses, such as a first data warehouse 161A, a second data warehouse 161B, a third data warehouse 161C, and so on. It should be recognized that the warehouse system 160 may include any number of data warehouses, such as an N^{th} data warehouse 161N (not shown). In one embodiment, the first data warehouse 161A represents data from a financial management system, the second data warehouse 161B represents data from a tax management system, and the third data warehouse 161C represents data from a credit report management system. It is to be understood that such representations are meant to be exemplary, and not limiting. For example, the third data warehouse 161C could represent data from a transaction management system, a social media system or the like.

It is to be understood that any number of data warehouses may be included in the data warehouse system 160. In one embodiment, each data warehouse of the data warehouse system 160 represents data from a respective domain of data that is different from other domains of data. For example, a service provider with four domains of data may have four data warehouses. In one embodiment, a data warehouse may represent data from multiple domains. For example, the first data warehouse 161A could represent data from a financial management system, a tax management system, and a credit report management system, such that the data from all three domains are combined into a single data warehouse. It is to be understood that a data warehouse may be located in physically separate locations from other data warehouses, or may be located in the same physical location as other data warehouses. It is to be further understood that although FIG. 1 depicts only one warehouse system 160, an embodiment can include a plurality of warehouse systems.

The aggregated statistics system 120 is configured to provide data management services to a plurality of clients. The aggregated statistics system 120 can be a standalone system that provides aggregated statistics services to clients through the client systems 131. Alternatively, the aggregated statistics system 120 can be integrated into other software or service products provided by the service provider. In one embodiment, the aggregated statistics system 120 improves client systems 131 by making available to clients aggregated statistical data that was previously unavailable to such clients. The aggregated statistics system 120 may include a data pipeline module 121, a statistics calculator module 122, a client interface module 123, an input interpreter module 124, and an output preparer module 125, according to various embodiments.

The aggregated statistics system 120 may include a data pipeline module 121. The data pipeline module 121 may be configured to extract data from the warehouse system 160. For example, the data pipeline module 121 may extract data from the first data warehouse 161A, the second data warehouse 161B, and the third data warehouse 161C. In one embodiment, the data pipeline module 121 extracts data from the warehouse system 160 via the communication channel 149. The data pipeline module 121 transmits the extracted data into a pipeline database 126 as pipeline data 127. In one embodiment, the data pipeline module 121 transmits the pipeline data 127 to the pipeline database via conduit 140. In one embodiment, the pipeline data 127 is made available by the pipeline database 126 on a runtime basis for use by the aggregated statistics system 120.

The aggregated statistics system 120 may include the client interface module 123 that is configured to communicate with the client computing environments 130 via the communication channels 141. The client computing environments 130 may include client systems 131. The clients of the aggregated statistics system 120 can use the client computing environments 130 to provide data to the aggregated statistics system 120 and to receive data, including aggregated statistic data, from the aggregated statistics system 120.

The clients of the aggregated statistics system 120 can include companies, businesses, organizations, government entities, individuals, groups of individuals, or any other entities for which aggregated statistic services would be beneficial, according to one embodiment. Individuals may utilize the aggregated statistics system 120 to track aggregated statistics. Furthermore, businesses of all kinds, including large corporations, midsize companies, small businesses, or even sole proprietor businesses, can utilize the aggregated statistics system 120. Likewise, government organizations may use the aggregated statistics system 120 to track various types of aggregated statistics. Organizations other than businesses and government entities, such as nonprofit organizations, may also utilize the aggregated statistics system 120 for the purpose of monitoring aggregated statistics. Thus, the term “client” can refer to many types of entities as discussed herein, as known at the time of filing, or as became known after the time of filing.

Each of the client systems 131 may include a query module 132 and a results module 133. The client systems 131 employ the query module 132 and the results module 133 to at least provide an interface with the aggregated statistics system 120, according to one embodiment. The query module 132 may display a query input screen to a client in order to collect query data from the client and to transmit the query data to the client interface module 123 via the communication channels 141. The results module 133 may display a results screen to a client in order to share the results of the query, such as an aggregated statistic, that was transmitted by the client interface module 123 via the communication channels 141. The query module 132 and the results module 133 may interface with a client through a web browser or through an application installed within the client computing environments 130, according to one embodiment. The client interface of the query module 132 and the results module 133 includes, but is not limited to, one or more dialog boxes, buttons, menus, directories, thumbnails, text boxes, radio buttons, check boxes, and other user interface elements to enable the client to interact with the aggregated statistics system 120.

The client interface module 123 of the aggregated statistics system 120 is configured to receive query data from the client systems 131 and to transmit results data to the client systems 131, according to one embodiment. The query data may specify a request for an aggregated statistic over a specified grouping of users. For example, the query data may request an average credit report score for 35-year-old users. The results data may be the aggregated statistic as well as additional information related to the aggregated statistic. For example, the results data may include a calculated average credit report score for 35-year-old users and a suggestion for how to improve one's credit report score.

In one embodiment, the client interface module 123 receives client queries for aggregated statistics from the client systems 131 and transmits responses to the queries to the client systems 131. In one embodiment, the client interface module 123 transmits the client queries to an input interpreter module 124 via a conduit 142. In one embodiment, the input interpreter module 124 translates client queries into one or more instructions for one or more calculations on one or more user data sets. In one embodiment, the input interpreter module 124 is configured to determine what a client is intending using machine learning and artificial intelligence.

In one embodiment, the input interpreter module 124 performs one or more machine learning algorithms in which feedback data is collected from a plurality of clients who have submitted queries to the aggregated statistics system. As the feedback data from the plurality of clients is collected, the machine learning algorithms may be improved or modified based on the feedback data by incorporating artificial intelligence into the machine learning algorithms. Accordingly, artificial intelligence mechanisms are used to improve the system on an ongoing basis. The input interpreter module 124 may perform one or more machine learning algorithms to improve the queries submitted by clients based on data collected from other clients. For example, a machine learning algorithm may detect, over time, that users from New York City are concerned about their housing costs and that demographically, users from New York City are more likely to rent than buy a residence. Based on this detection, the machine learning algorithm may modify a client's query to include grouping profiles that differentiate between home ownership and home rental, providing clients from New York City with a more useful result due to renting being more prevalent in New York City.

In one embodiment, the input interpreter module 124 determines that the data for a specific client is to be compared with data for users having values that are designated as similar. For example, a query for an average credit score can be for all users having the exact same age as the client, such as 35 years old, or for all users having ages near the age of the client, such as 34 to 36. In one embodiment, a similar age can be the exact same age. In another embodiment, a similar age can be a range of ages. For further example, a query for an average annual income can be for all users having the exact same occupation as the client, such as accountant, or for users having a similar occupation (e.g., for an accountant, similar users may be financial services professionals). In one embodiment, the input interpreter module 124 can utilize machine-learned models that, for example, adds intelligence to the input interpreter module 124. It is to be understood that the input interpreter module 124 can receive a plurality of variables of a query for data matching. In one embodiment, the machine-learned models can be utilized to determine what similar means for a particular client.

In one embodiment, the machine-learned models are utilized to determine groupings of users based on the pipeline data 127, clusters of users based on the pipeline data 127, cohorts of users based on the pipeline data 127, or the like. In one embodiment, data about a client is acquired by the input interpreter module 124, and a machine-learned model analyzes the statistic that will be aggregated, and based on that analysis, a definition of one or more groupings of users is determined that is likely to be useful to the client. In one embodiment, a machine-learned user grouping may be determined independently of client defined user groupings, such as a grouping around a client's age. For example, if a client requests a user grouping of an age of 35 years old, the machine-learned model may determine that a more appropriate grouping is a range of ages from 30 to 40. For further example, if a client requests a user grouping of a profession of accountant, the machine-learned model may determine that a more appropriate grouping is the finance profession. For further example, if a client requests a user grouping of a zip code in San Diego for software professionals, the machine-learned model may determine that a more appropriate grouping is a zip code in the Silicon Valley area because, for example, there may be more software professionals (i.e., relevant comparison points) in the Silicon Valley area than in San Diego. The input interpreter module 124 may utilize machine learning and artificial intelligence to map a particular query of a client to make comparisons across a lager data set of the pipeline data 127, such as mapping the query to user groupings that are determined to be appropriately similar to the client. In some embodiments, the number of users of a user grouping may be increased or broadened in order to have a large enough sample to provide a client with a sufficiently large representative sample. In some embodiments, the number of users of a user grouping may be decreased or narrowed in order to remove outlier data points from the sample to provide a client with a sufficiently matching representative sample.

In one embodiment, the input interpreter module 124 utilizes machine learning and artificial intelligence to determine one or more group profiles for a client, into which the client fits. For example, the data of a client may fit with the data of various groups of users. For example, based on age, a client may fit in one group profile. For further example, based on income, a client may fit in another group profile. For further example, based on occupation, a client may fit in another group profile. In one embodiment, the input interpreter module 124 determines a plurality of different groups that are appropriate to the client.

In one embodiment, the input interpreter module 124 transmits one or more instructions to the statistics calculator module 122 via the conduit 144. The statistics calculator module 122 includes a calculation engine that can calculate aggregated statistics over sets of data. An example statistics calculator module 122 is Elasticsearch®, available from Elasticsearch, Inc. of Mountain View, Calif. The statistics calculator module 122 is able to receive a plurality of calculation instructions from the input interpreter module 124 from which each respective aggregated statistic can be calculated. The statistics calculator module 122 may receive the pipeline data 127 from the pipeline database 126 via a conduit 145. The statistics calculator module 122 may perform aggregated statistical calculations on the pipeline data 127 based on the user groupings defined in the instructions received from the input interpreter module 124.

In one embodiment, each calculation instruction represents a statistic to be calculated over a group profile, a user grouping, and the like. For example, a client may provide a client query that requests a statistic of average credit scores for users like the client. The input interpreter module 124 may interpret users like the client to be several group profiles, such as users of a similar age, similar occupation, similar income, and similar zip code. The input interpreter module 124 may create four instructions for the statistics calculator module 122, such as a first instruction to calculate an average credit score over user data associated with the client's age, a second instruction to calculate an average credit score over user data associated with the client's occupation, a third instruction to calculate an average credit score over user data associated with the client's income, and a fourth instruction to calculate an average credit score over user data associated with the client's zip code. Thus, a single query from a client can be mapped by the input interpreter module 124 into multiple instructions representing different queries for the statistics calculator module 122 to calculate.

In one embodiment, the input interpreter module 124 receives the pipeline data 127 via the conduit 143. For example, the pipeline data 127 may represent data about users. Such user data may comprise information about a user that can be utilized by the input interpreter module 124 to determine applicable interpreted queries from a client's query. Such user data can be used by the input interpreter module 124 to perform intelligent grouping functionality, for example, using machine learning and artificial intelligence. In one embodiment, such user data may be tax data, profile data, credit report data, and the like. In one embodiment, instead of receiving the pipeline data 127 from the pipeline database 126, the user data may be received directly from the warehouse system 160.

In one embodiment, the warehouse system 160 comprises data about a plurality of users of one or more management systems such as transaction management systems, social media management systems, and the like. The data pipeline module 121 of the aggregated statistics system 120 imports the user data into the pipeline database 126. In one embodiment, the data pipeline module 121 manipulates the imported data, such as classifying it, grouping it, combining it, filtering it, and the like, before or after it is stored as the pipeline data 127. When the client interface module 123 receives a query request from a client, after the query request is passed to the input interpreter module 124, in one embodiment the input interpreter module 124 utilizes the pipeline data 127, or data directly from the warehouse system 160, to determine what is known about the client. The determination of what is known about the client may then be correlated with other data of the pipeline data 127. In one embodiment, this correlation is an intelligent correlation based on machine learning algorithms. In one embodiment, one or more group profiles may be determined in association with the client's query request. For example, a group profile may be based on where the client lives, how old the client is, what the client does for a living, and the like. Multiple group profiles may be determined based on such information.

In one embodiment, a feedback loop is utilized to determine a set of group profiles, in relation to a client query. Such a feedback loop may, for example, assist in analyzing a client query. For example, a client query may include a criteria of “like me,” in which a client is asking for a statistic over data representing other users that are similar to the client. Machine learning algorithms can monitor a client's feedback of responsiveness to a selected group profile, and refine what “like me” means for the client. For example, “like me” may mean users who live in a certain location for one client, but may mean users who earn a certain income for another client. It is to be understood that a “like me” query request may have many dimensions, such as a data scientist who lives in Silicon Valley and has no children. Through a feedback loop of client responses to aggregated statistic results based on a machine-learned determination of a group profile, a determination of “like me” can be improved. Furthermore, a group profile for a specific client may be based on feedback loops received from other clients. In one embodiment, a feedback loop may comprise receiving data from a client indicating that they approve the determined group profile, or that the group profile is not providing the information that they had in mind. For example, a client can be given an option to select whether they like or do not like the determined group profile, and the machine learning algorithms can learn from the client selection using artificial intelligence.

In one embodiment, the aggregated statistics system 120 includes an output preparer module 125. The output preparer module 125 may receive calculation data from the statistics calculator module 122 via the conduit 146. The output preparer module 125 may prepare the calculation data into query results data, and pass the query results data to the client interface module 123 via the conduit 147. The client interface module 123 may transmit the query results to the respective client system of the client systems 131 via the communication channels 141. The respective client system of the client systems 131 may provide the query results to the client via the results module 133.

In one embodiment, the output preparer module 125 analyzes multiple calculation results from the statistics calculator module 122. For example, the input interpreter module 124 may provide multiple instructions to the statistics calculator module 122 to perform multiple calculations based on a plurality of group profiles or user groupings. After the statistics calculator module 122 performs the calculations based on the multiple instructions, the multiple calculation results are transmitted to the output preparer module 125. The output preparer module 125 may review the multiple calculation results to select the best result or the appropriate result to return to the client systems 131. For example, the output preparer module 125 may utilize a machine learning algorithm to determine which calculation result provides the most useful result based, at least in part, on the respective group profile of the multiple group profiles.

In one embodiment, the output preparer module 125 uses a feedback loop with the client to determine which result the client is most likely to want. It is to be understood that a feedback loop can be utilized by the output preparer module 125 to determine which of a plurality of calculation results should be prepared for the client. For example, in the past, the output preparer module 125 may have determined that an appropriate calculation result was related to a client's location. However, based on a feedback loop with the client, an improved or refined calculation result may be related to a client's marital status. In one embodiment, the output preparer module 125 determines what a client's designation of “like me” means. In one embodiment, this determination is made in coordination with the input interpreter module 124. In one embodiment, this determination is made independently from the input interpreter 124. In one embodiment, this determination provides the most applicable query result to the client based on what is currently known about the client from the pipeline data 127 and feedback loop data. In one embodiment, the feedback loop data is appended to the pipeline data 127.

As depicted in FIG. 1 through double lines for the conduit 144 and the conduit 146, the input interpreter module 124 may receive as input a client query, and split the client query into multiple queries with respective calculations to be performed by the statistics calculator module 122. It is to be understood that although two lines are depicted in FIG. 1 for the conduit 144 for two sets of instructions, there may be any number of sets of instructions including just a single instruction for a single calculation. The output preparer module 125 may receive a plurality of calculation results from the statistics calculator module 122 for each set of instructions of the input interpreter module 124. It is to be understood that although two lines are depicted in FIG. 1 for the conduit 146 for two query results, there may be any number of query results including just a single query result from a single calculation. In one embodiment, the output preparer module 125 decides which calculation result to return to the client systems 131. In one embodiment, this decision is based on an optimization for a result that is most interesting to a client based on a feedback loop or the like.

In one embodiment, in lieu of a feedback loop or in addition to a feedback loop, the aggregated statistics system 120 includes a module (not shown) for data scientists to add group profile rules or group profile filters to the pipeline data 127. For example, a data scientist may add a group profile rule for a certain client type within a particular age group, in a particular field, and having a particular income bracket, that appropriately defines the group profile or user grouping. In one embodiment, the group profile is defined with specific information. For example, a data scientist can define that clients who are millennials are defined primarily by their home location, such that when a millennial makes a query request of “like me,” an appropriate group profile is set through rules or filters to be home location. In one embodiment, the aggregated statistics system is configured to allow for generalized assumptions about group profiles and user groupings in order to determine what a client means by “like me.”

In one embodiment, the aggregated statistics system 120 is configured to present interesting data to a client. In one embodiment, the client systems 131 are configured to receive interesting data from the aggregated statistics system 120, in which the interesting data is a comparison of a detail about the client with details of a population of users. In one embodiment, a framework for a detail of a client may be related to a client's financial profile, a small business profile, a tax profile, or the like. For example, a detail of the client may be related to a client's financial position, and the comparison is a statistical determination of how the client ranks against an element of the framework. In one embodiment, the client systems 131 are configured to allow the client to define the framework. For example, a client may request an average credit score for other users with the same age, in which the framework encompasses credit score data originating from the first data warehouse 161A that may represent credit report data, and encompasses age data originating from the second data warehouse 161B that may represent tax data. In this example, an age may be 30. In one embodiment, the input interpreter module 124 may expand the description of age from 30 years old to a range such as 25 years old to 35 years old. In one embodiment, the client may request an average credit score for users “like me,” in other words, like the client.

In one embodiment, the client systems 131 may comprise a client-facing application that provides a service to clients. In one embodiment, a client-facing application may be a tax management application, a personal finance management system, or the like. In one embodiment, the client-facing application may comprise a composite of various applications, such as a composite of tax management services, personal finance management services, and other services that can comprise an application suite. In one embodiment, the client systems 131 may comprise back-end applications for use by entities desiring to utilize the aggregated statistics system 120. In one embodiment, client systems 131 could comprise an electronic commerce system, a web search engine, or the like. For example, an electronic retailer could offer to clients a product, such as a lawn mower. The application of the electronic retailer could provide a client with information about how much typical users spend on lawn mowers, where typical users are similar to the client. In this example, the electronic retailer is able to take advantage of the aggregated statistics system 120 in order to provide interesting data to a client about shopping for lawn mowers. Similarly, an electronic bank that is offering an individual retirement account to a client can determine through the aggregated statistics system 120 an account that is most popular with users who are similar to the client. Accordingly, the aggregated statistics system 120 may make available proprietary data from the warehouse system 160 in the form of aggregated statistics that comply with data governance policy.

In one embodiment, the data pipeline module 121 extracts data from the warehouse system 160 and imports the data into the pipeline database 126 via the conduit 140. For example, the data pipeline module 121 may extract data from the first data warehouse 161A, the second data warehouse 161B, the third data warehouse 161C, and other data warehouses that the warehouse system 160 may include. In one embodiment, the data pipeline module 121 may have rules that restrict what data may be imported into the pipeline database 126. For example, social security numbers may be determined to be inconsequential for responding to client queries, and a rule may be applied that restricts social security numbers from being imported into the pipeline database 126. For further example, a user may opt not to have the user's data used for aggregated purposes, and data for such users that have not given consent may be restricted from being imported by the data pipeline module 121.

In one embodiment, the data pipeline module 121 extracts data from the warehouse system 160 on an off-line basis. In one embodiment, the pipeline data 127 that is imported into the pipeline database 126 is available on a run-time basis. In one embodiment, the pipeline data 127 comprises data that is allowed to be queried for aggregated statistics. In one embodiment, the data pipeline module 121 filters the imported data into allowable pipeline data 127.

In one embodiment, the data pipeline module 121 performs data fusion on the pipeline data 127. In one embodiment, data fusion includes analyzing data from multiple sources of truth and resolving them into single data in the pipeline data 127. For example, a user's age may have a source in the first data warehouse 161A that may represent data from a personal finance management system. The personal finance management system may ask a user to input the user's age. Because this is a self-reported age, it may be incorrect. Furthermore, after a year, the age may be out of date because the user is one year older. Thus, the level of fidelity of the source of truth for age data from the first data warehouse 161A may be ranked low.

For further example, a user's age may have a source in the second data warehouse 161B that may represent data from a tax management system. The tax management system may ask a user for a birth date in order to file a tax return with a government agency. This may be a self-reported birth date, and even though a user may desire for it to be correct because it will be reported to a government agency, the tax return may nevertheless be filed with an incorrect birthday. Thus, the level of fidelity of the source of age data from the second data warehouse 161B may be ranked higher than that for the first data warehouse 161A, but not much higher.

For further example, a user's age may have a source in the third data warehouse 161C that may represent data from a credit report management system. The credit report management system may ask a user for a birth date in order to pull a credit report from a credit reporting agency. The credit reporting agency may not release a credit report of a user unless the birth date is accurate. Accordingly, the receipt of a credit report for a user from a credit report agency is an indication that the birth date provided by the user is accurate. Thus, the level of fidelity of the source of age data from the third data warehouse 161C may be ranked higher than that for both the first data warehouse 161A and the second data warehouse 161B.

Under these examples, the data pipeline module 121 utilizes data fusion algorithms to rank similar data based on the level of fidelity of the source of the data. In one embodiment, a level of fidelity is based on rules that the data pipeline module 121 employs. For example, a rule may provide a precedence of one data source over another. Using the prior examples, a rule may state that age data from the third data warehouse 161C takes precedence over age data from the second data warehouse 161B and the first data warehouse 161A. However, if age data from the third data warehouse 161C is unavailable, then age data from the second data warehouse 161B takes precedence over age data from the first data warehouse 161A. However, if age data from the second data warehouse 161B is unavailable, then age data from the first data warehouse 161A is utilized.

Another example of data fusion can be applied to a home ownership status of a user. For example, a user's home ownership status may have a source in the first data warehouse 161A that may represent data from a personal finance management system. The personal finance management system may ask a user to input whether it owns a home. Furthermore, the personal finance management system may have data related to a mortgage account that would indicate home ownership. For further example, a user's home ownership status may have a source in the second data warehouse 161B that may represent data from a tax management system. The tax management system may collect information about a user's deductions related to home ownership on a tax return. For further example, a user's home ownership status may have a source in the third data warehouse 161C that may represent data from a credit reporting management system. The credit reporting management system may include mortgage payment history from a user's credit report.

In one embodiment, data fusion rules may be determined using machine learning algorithms. Using the prior examples of home ownership status, the level of fidelity of a source of truth can be ascertained based on a machine-learned statistical confidence system. In one embodiment, a machine-learned statistical confidence model can determine a level of fidelity for the source of truth for home ownership status data. In one embodiment, the determination is based on historical data, such as analyzing for overlapping data sets. In one embodiment, a machine-learned statistical model is an intelligent model based on a comparison of data across data warehouses of the warehouse system 160.

In one embodiment, a client makes a query request through a client system of the client systems 131. The client systems 131 transmit query requests through the client interface module 123, which is a publicly-facing interface. In one embodiment, the client systems 131 are enabled to allow a client to ask for an aggregated statistic over a grouping profile of users. In one embodiment, the grouping profile is a grouping of users similar to the client, which the client may think of as “like me.” For example, a client may request an average credit rating for “people like me.” In one embodiment, a client may request a percentage breakdown statistic over a grouping profile. For example, a client may request a percentage breakdown of users who are the client's age and who own a home. The input interpreter module 124 may interpret such as a request not only for a percentile of people who own a home but also for a percentile of people who do not own a home.

In one embodiment, the client interface module 123 may be configured to enforce security requirements. For example, the client interface module 123 may ensure that clients are authenticated, that the client systems 131 are trusted, that the client systems 131 have rights to the data, and the like to enforce security policies for public-facing interfaces.

In one embodiment, the input interpreter module 124 is configured to receive from the client systems 131 the group profile or the user grouping requests such as age, income, city, state, zip code, occupation, debt, home ownership, marital status, and the like. In one embodiment, the input interpreter module 124 is configured for intelligent grouping functionality, such as allowing “like me” requests. For example, a client's request for a grouping profile of “like me” may be interpreted through machine learning and artificial intelligence to be based on the client's age. For further example, a machine-learned model may examine the client's credit card debt, home ownership status, and marital status and determine that “like me” can be interpreted to include these three areas in a grouping profile.

In one embodiment, the input interpreter module 124 performs intelligent grouping of users based on the client system of the client systems 131. For example, with client systems 131 that are tax management systems, a rule could be created that a client is shown data that is interesting on the home page of the tax management system. For example, clients of the tax management system may always be shown an average credit score that is calculated without the need for a direct client query request. In one embodiment, interesting data can be determined by the input interpreter module based on machine-learned models. For example, a machine-learned model utilized by the input interpreter module 124 may have learned that clients from Southern California are interested in facts about income, while clients from New England are interested in facts about mortgage debt. The client interface module 123 can present the appropriate interesting data to the client based on a determination of a machine-learned model.

In one embodiment, the input interpreter module 124 receives queries from the client interface module 123, and utilizes pipeline data 127 about the client to determine whether the received query should be transformed into multiple user groupings based on different elements of group profiles. In one embodiment, the user groupings are based on input queries from the client systems 131. Input queries may include user groupings of “like me,” which the input interpreter module 124 intelligently interprets using machine-learned models. In one embodiment, machine-learned models broaden a client's requested user grouping. For example, if a client requests a user grouping of 30-year-old users, the input interpreter module 124 may determine that based on the client's stage in life, an improved user grouping would be an age range from 25 to 35 years.

In one embodiment, the input interpreter module 124 may broaden a query from a client, which may result in a more valuable or useful answer to the client. For example, a query may be improved by broadening it to include more data points such as a larger age range. In another embodiment, the input interpreter module 124 may narrow a query from a client. For example, although the client requested a query based on an age of 30, there may be enough data points around the birth month of the client to narrow the query to users born in the same month as the client. It is to be understood that broadening or narrowing a query can be done in any combination over data fields, such as one field being broadened and another field being narrowed, which may result in a more valuable answer to the client.

In one embodiment, the statistics calculator module 122 receives at least one set of instructions to perform statistical calculations over each group profile or user grouping. The statistics calculator module 122 performs the statistical calculations and transmits the same number of aggregated statistics to match the received sets of instructions to the output preparer module 125. In one embodiment, the statistics calculator module 122 may be configured to calculate aggregated statistics such as minimums, maximums, means, medians, counts, percentiles, standard deviations, percentage breakdowns, and the like.

In one embodiment, the output preparer module 125 receives at least one calculation result from the statistics calculator module 122. In one embodiment, when the output preparer module 125 receives two or more calculation results from the statistics calculator module 122, the output preparer module 125 can determine which calculation result is to be returned to the client based on, for example, logic rules, machine-learned algorithms, or the like. In one embodiment, the statistics calculator module 122 may receive instructions from the input interpreter module 124 to perform, for example, three sets of calculations based on three interpretations of the client's query. The instructions may be based on intelligent grouping profiles. The statistics calculator module 122 may perform the three sets of calculations and calculate three aggregated statistics. The statistics calculator module 122 may send the three aggregated statistics to the output preparer module 125. The output preparer module 125 may then determine which of the three aggregated statistics are to be sent to the client interface module 123. For example, one of the three aggregated statistics may be determined to be more likely to be what the client was seeking.

In one embodiment, the output preparer module 125 may use business logic such as providing an aggregated statistic to a client that puts the client closest to a mean. Other examples of business logic may be to choose an aggregated statistic that puts the client's results at the high-end or the better end of a distribution, or alternatively, the low-end or the worse end of a distribution. In one embodiment, there may be multiple different statistics that can be calculated over multiple groups. In one embodiment, the statistic chosen to be returned to the client systems 131 may be based on business logic comprising, for example, a fixed heuristic of rules used to select one of the statistics. For example, if a client requests an average credit score for users of a certain age, a business rule may return the statistic over a group that puts the user at the highest end of the spectrum of the population of users selected within the group. In one embodiment, a population of users may be divided or sliced up into multiple sets of groups. For example, a client who is a data scientist may have a higher credit score compared to other data scientists, however when compared to others of the same age, the client's credit score may be lower. In this example, a business rule may provide for returning the statistic that puts the client at the higher end of the spectrum of other data scientists.

In one embodiment, the statistics chosen to be returned to the client systems 131 may be based on machine learning and artificial intelligence. In one embodiment, a heuristic may be intelligently chosen that provides each client with a result that is interesting to the respective client, such as a result that is engaging to the client. In one embodiment, a closed-loop intelligence model can be utilized in which a prior determination is made on a statistic, feedback about the prior determination is received from a client, and a future determination is made based in part on that client feedback. For example, if it is determined that a client favors statistics over age more than statistics over occupation, then the next determination may favor statistics over age. In one embodiment, a closed-loop intelligence model may be beneficial to provide statistics to clients that cause clients to feel good and inspire them to continue to utilize the client systems 131.

It is to be understood that with statistical comparisons, some clients will have data that fit on the low end of certain spectrums, and other clients will have data that fit on the high end of certain spectrums. It is to be understood that data of a client may fit at the low end of one spectrum and yet fit at the high end of another spectrum. Because different clients may have different motivations, such as some clients may be discouraged at being at a low end while others may be inspired to improve, a closed loop intelligence model of the aggregated statistics system 120 can provide a statistic that induces an appropriate level of motivation to each client based on feedback about a prior statistic. Furthermore, changes in statistics over time can be provided to clients, such as demonstrating movement from a low end of a spectrum to being closer to the mean. By segmenting a population of users within a closed loop intelligence model, the aggregated statistics system 120 is afforded a level of flexibility to choose between different groupings of users in order to provide a client with meaningful statistics. For example, a baby boomer may interpret a statistic in one way while a millennial may interpret the same statistic in another way, and a closed-loop intelligence model may detect those differences between clients as feedback is collected from these two population groups. The closed loop intelligence model may thus detect that millennials react positively to a statistic related to user grouping of home renters while baby boomers react positively to a statistic related to a user grouping of home owners and present relevant statistics to different users based on user membership in a particular group of users (or similarity to a particular group of users).

In one embodiment, the aggregated statistics system 120 can provide advice with an aggregated statistic. For example, if a credit score statistic is transmitted to the client systems 131, then a link to advice about improving credit scores may also be transmitted to the client systems 131. Such advice may include information about improving the client's credit score. In one embodiment, the results module 133 may display to a client information associated with an aggregate statistic. For example, information about a credit score may include contact information for a client to correct an incorrect credit score. Such may be beneficial for clients who receive aggregated statistics that are unfavorable to allow the clients to improve the aggregated statistics over time. In one embodiment, a client system of the client systems 131 may not be client facing. For example, such a client system may be a marketing tool that can utilize the aggregated statistics system 120 for targeted advertising, targeted offers, and the like.

In one embodiment, the output preparer module 125 enforces data privacy rules. For example, if an aggregated statistic is based on too few users, then such an aggregated statistic is not returned to the client systems 131. In this example, the statistics calculator module 122 may transmit to the output preparer module 125 privacy information about each calculated aggregated statistic so that the output preparer module 125 can make privacy determinations about each calculated aggregated statistic. In one embodiment, privacy information may be a count of users associated with the grouping of user data, and a threshold number of users may be set to allow an aggregated statistic to be returned to the client systems 131. In one embodiment, a distribution of user data may be analyzed to determine sufficient distribution breadth to meet data privacy standards. It is to be understood that the output preparer module 125 may use other statistical analyses to determine whether an aggregated statistic complies with data privacy policy.

It is to be understood that, in some embodiments, the modularized intelligence of the input interpreter module 124 and the output preparer module 125 have been described as two modules, but under an embodiment these two modules may be combined into a single module or further divided into additional modules. It is to be understood that these two modules may interact with each other, for example, in determining the interpretation of client queries and the preparation of query results.

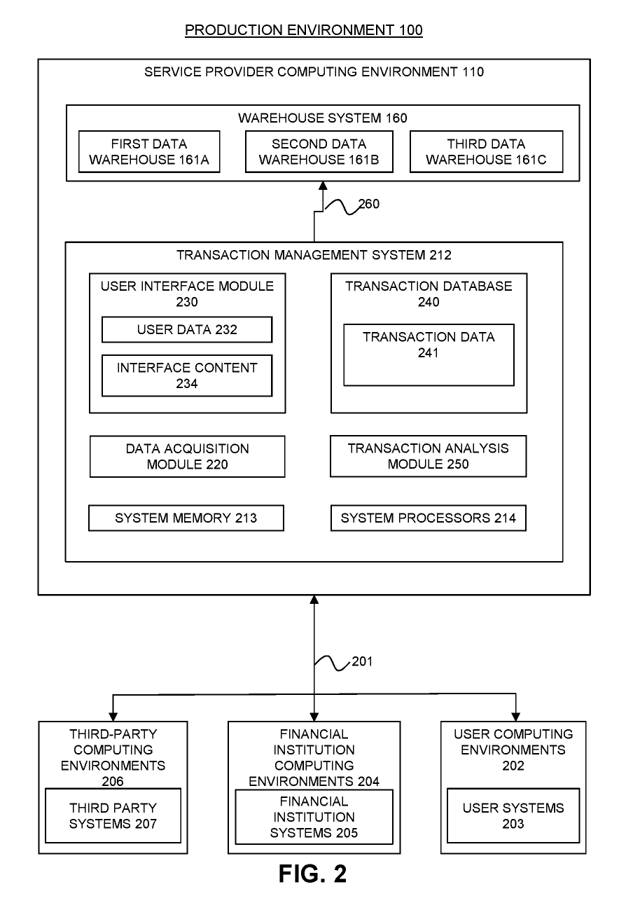

FIG. 2 is a functional block diagram of a production environment 100 for aggregated statistics generation over sets of user data while enforcing data governance policy, in accordance with various embodiments. It is to be understood that the diagram of FIG. 2 is for exemplary purposes and is not meant to be limiting. For example, the transaction management system 212 may apply to any manner of transactions, such as social media posting transaction management, financial transaction management, real estate transaction management, governmental electronic governance transaction management, and the like. Referring to FIGS. 1 and 2 together, the production environment 100 includes a service provider computing environment 110, user computing environments 202, financial institution computing environments 204, and third-party computing environments 206, according to various embodiments. The computing environments 110, 202, 204, and 206 are communicatively coupled to each other with one or more communication channels 201, according to various embodiments. Communication channels 201 may include one or more physical or virtual networks.

The service provider computing environment 110 includes the transaction management system 212, which is configured to provide transaction management services to a plurality of users. According to one embodiment, the transaction management system 212 is an electronic financial accounting system that assists users in bookkeeping or other financial accounting practices. Additionally, or alternatively, the transaction management system 212 can manage one or more of tax return preparation, banking, investments, loans, credit cards, real estate investments, retirement planning, bill pay, and budgeting. The transaction management system 212 can be a standalone system that provides transaction management services to users. Alternatively, the transaction management system 212 can be integrated into other software or service products provided by a service provider. In one embodiment, the service provider computing environment 110 includes system memory 213 and system processors 214. It is to be understood that the aggregated statistics system 120 and the transaction management system 212 may be the same system or different systems under various embodiments.

In one embodiment, the transaction management system 212 can assist users in tracking expenditures and revenues by retrieving transaction data related to transactions of users. The transaction management system 212 may include a data acquisition module 220, a user interface module 230, a transaction database 240, and a transaction analysis module 250, according to various embodiments.

The user computing environments 202 correspond to computing environments of the various users of the transaction management system 212. The user computing environments 202 may include user systems 203. The users of the transaction management system 212 utilize the user computing environments 202 to interact with the transaction management system 212. The users of the transaction management system 212 can use the user computing environments 202 to provide data to the transaction management system 212 and to receive data, including transaction management services, from the transaction management system 212. It is to be understood that the client systems 131 and the user systems 203 may be the same systems or different systems under various embodiments.

The user interface module 230 of the transaction management system 212 is configured to receive user data 232 from the users, according to one embodiment. The user data 232 may be derived from information, such as, but not limited to a user's name, personally identifiable information related to the user, authentication data that enables the user to access the transaction management system, or any other types of data that a user may provide in working with the transaction management system 212.

In one embodiment, the user interface module 230 provides interface content 234 to the user computing environments 202. The interface content 234 can include data enabling a user to obtain the current status of the user's financial accounts. For example, the interface content 234 can enable the user to select among the user's financial accounts in order to view transactions associated with the user's financial accounts. The interface content 234 can enable a user to view the overall state of many financial accounts. The interface content 234 can also enable a user to select among the various options in the transaction management system 212 in order to fully utilize the services of the transaction management system 212.

In one embodiment, the transaction management system 212 includes a transaction database 240. The transaction database 240 includes the transaction data 241. The transaction data 241 may be derived from data indicating the current status of all of the financial accounts of all of the users of the transaction management system 212. Thus, the transaction database 240 can include a vast amount of data related to the transaction management services provided to users. In one embodiment, when the user utilizes the user interface module 230 to view interface content 234, the interface content 234 includes the transaction data 241 retrieved from the transaction database 240.

In one embodiment, the data acquisition module 220 is configured to use the financial institution authentication data provided in the user data 232 to acquire transaction data 241 related to transactions of the users from the financial institution systems 205 of the financial institution computing environments 204. In addition, the data acquisition module 220 may use the financial institution authentication data to log into the online services of third-party computing environments 206 of third-party institutions in order to retrieve transaction data 241 related to the transactions of users of the transaction management system 212. The data acquisition module 220 accesses the financial institutions by interfacing with the financial institution computing environments 204. The transaction data of the financial institution systems 205 may be derived from bank account deposits, bank account withdrawals, credit card transactions, credit card balances, credit card payment transactions, online payment service transactions, loan payment transactions, investment account transactions, retirement account transactions, mortgage payment transactions, rent payment transactions, bill pay transactions, budgeting information, or any other types of transactions. The data acquisition module 220 is configured to gather the transaction data 241 from financial institution computing environments 204 related to financial service institutions with which one or more users of the transaction management system 212 have a relationship.

In one embodiment, the data acquisition module 220 is configured to acquire data from third-party systems 207 of third-party computing environments 206. The data acquisition module 220 can request and receive data from the third-party computing environments 206 to supply or supplement the transaction data 241, according to one embodiment. In one embodiment, the third-party computing environments 206 automatically transmit transaction data to the transaction management system 212 (e.g., to the data acquisition module 220), to be merged into the transaction data 241. The third-party computing environment 206 can include, but is not limited to, financial service providers, state institutions, federal institutions, private employers, financial institutions, social media, and any other business, organization, or association that has maintained financial data, that currently maintains financial data, or which may in the future maintain financial data, according to one embodiment.

The data acquisition module 220 of the transaction management system 212 may be configured to receive from the financial institution systems 205 one or more transactions associated with the user. The data acquisition module 220 may store the received transactions as transaction data 241. The transaction analysis module 250 of the transaction management system 212 may analyze the transactions stored as the transaction data 241.

In one embodiment, the transaction data 241 may be transmitted to the warehouse system 160 via communication channel 260. The transaction data 241 may be stored in one of the data warehouses, such as the first data warehouse 161A. In one embodiment, the user data 232 may be transmitted to the warehouse system 160 via communication channel 260. The user data 232 may be stored in one of the data warehouses, such as the first data warehouse 161A. It is to be understood that the warehouse system 160 and the transaction management system 212 may be the same system or different systems under various embodiments. For example, the transaction database 240 may reside within the first data warehouse 161A or another data warehouse of the warehouse system 160.

### Process

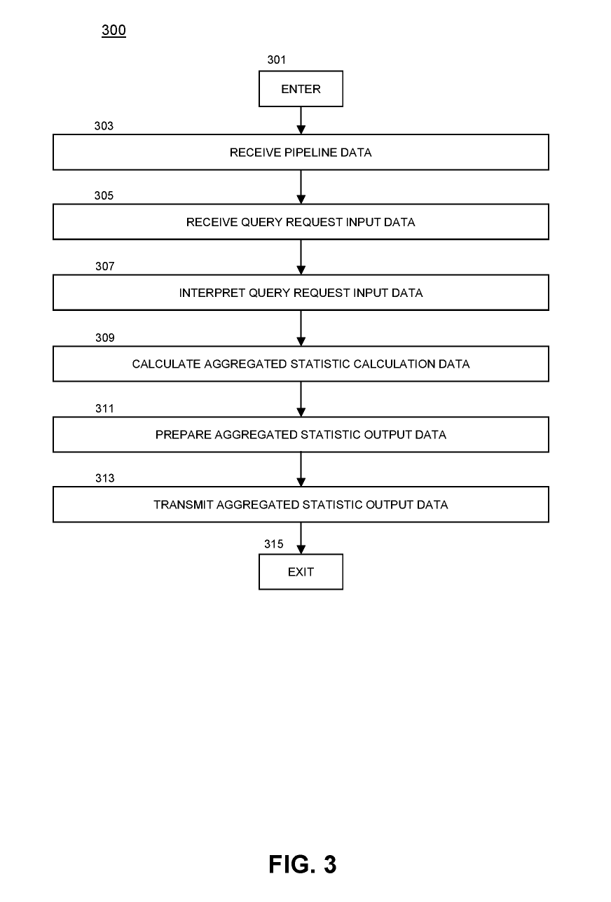

FIG. 3 is a flow diagram of a process 300 for aggregated statistics generation over sets of user data while enforcing data governance policy, in accordance with various embodiments. Referring to FIGS. 1 and 3 together, the process 300 for generating aggregated statistics over sets of user data while enforcing data governance policy begins at ENTER OPERATION 301 and process flow proceeds to RECEIVE PIPELINE DATA OPERATION 303.

In one embodiment, at RECEIVE PIPELINE DATA OPERATION 303, the data pipeline module 121 is configured to receive the pipeline data 127 from at least one data warehouse of the warehouse system 160. For example, the data pipeline module 121 may be configured to receive the pipeline data 127 from the first data warehouse 161A, the second data warehouse 161B, and the third data warehouse 161C. In one embodiment, the data pipeline module 121 is configured to perform data fusion on the pipeline data 127. In one embodiment, the data fusion resolves at least one source of truth. For example, the first data warehouse 161A may store a first address of a user and the second data warehouse 161B may store a second address of the same user, and the first address and the second address are different. Data fusion utilizes an algorithm to analyze data from multiple sources of truth, such as the first data warehouse 161A and the second data warehouse 161B, and resolving them into single data, such as a single address, in the pipeline data 127. In one embodiment, the data pipeline module 121 performs data fusion through business rules, such that data is taken from multiple potential sources of truth and resolved to a single piece of data to be exposed in the pipeline database 126. In one embodiment, the data pipeline module 121 performs data fusion through machine-learned models.

In one embodiment, the data pipeline module 121 periodically executes to extract the pipeline data 127 from multiple data warehouses of the warehouse system 160. In one embodiment, it is desired to make the pipeline data 127 available to the client systems 131. The data pipeline module 121 results in a set of pipeline data 127 that is loaded into the aggregated statistics system 120, which is a runtime system under one embodiment. In one embodiment, the data pipeline module 121 stores the pipeline data 127 in the pipeline database 126 where, for example, it is ready to be queried.

In one embodiment, once the pipeline data 127 is received by the data pipeline module 121 at RECEIVE PIPELINE DATA OPERATION 303, process flow proceeds to RECEIVE QUERY REQUEST INPUT DATA OPERATION 305.

In one embodiment, at RECEIVE QUERY REQUEST INPUT DATA OPERATION 305, the client interface module 123 receives from the client system 131 the query request input data representing a query request of a client of the client system 131. In one embodiment, the query request comprises an aggregated statistic request and a grouping profile request. For example, an aggregated statistic request may be an average credit score and a grouping profile request may be users who are 30-years-old.

In one embodiment, the query request input data is received from a client of the client system 131 through the query module 132 of the client system 131. In one embodiment, the query module 132 acquires the query request input data from the client. For example, the query module 132 may cause an input screen to be displayed to the client into which the client can enter the query request input data. In one embodiment, the query module 132 provides a client with a user interface. In one embodiment, before receiving the query request input data, the client interface module 123 enforces security requirements with the client system 131. For example, the client interface module 123 may confirm that the client system 131 is authenticated and the like.

In one embodiment, the client system 131 makes requests to the client interface module 123, which is a publicly facing interface. In one embodiment, the requests describe the desired statistics and how the user grouping is to be performed. In one embodiment, the client interface module 123 is responsible for enforcing any security requirements required by the aggregated statistics system 120. For example, a security requirement may be that a request for data comes from trusted or authenticated entities.

In one embodiment, once the query request input data is received by the client interface module 123 at RECEIVE QUERY REQUEST INPUT DATA OPERATION 305, process flow proceeds to INTERPRET QUERY REQUEST INPUT DATA OPERATION 307.

In one embodiment, at INTERPRET QUERY REQUEST INPUT DATA OPERATION 307, the input interpreter module 124 interprets the query request input data into calculation instruction data representing at least one calculation instruction. In one embodiment, the at least one calculation instruction comprises an aggregated statistic definition interpreted from the aggregated statistic request and at least one grouping profile definition interpreted from the grouping profile request. In one embodiment, the at least one grouping profile definition is interpreted from the grouping profile request based in part on the pipeline data 127 associated with a client of the client system 131. In one embodiment, the at least one calculation instruction is interpreted with at least one machine-learned interpretation model. For example, the at least one machine-learned interpretation model may be generated from feedback data of the client of the client system, and the feedback data may be associated with previous aggregated statistic output data having been previously transmitted to the client system.

In one embodiment, the input interpreter module 124 receives the query request input data from the client interface module 123. In one embodiment, the input interpreter module 124 receives pipeline data 127 related to users. In one embodiment, the pipeline data 127 is received from user data storage sources.

In one embodiment, the query request input data is mapped into multiple calculations over user groupings to be performed by the statistics calculator module 122. In one embodiment, the user groupings are based on the query request input data from the client system 131. In one embodiment, the user groupings are based in part on intelligence and the pipeline data 127 related to users to determine potentially better groupings. For example, if the client is requesting a statistic for the group of users of a specific age, the input interpreter module 124 may translate the request into a request for a statistic for a range of ages.

In one embodiment, once the query request input data is interpreted by the input interpreter module 124 at INTERPRET QUERY REQUEST INPUT DATA OPERATION 307, process flow proceeds to CALCULATE AGGREGATED STATISTIC CALCULATION DATA OPERATION 309.

In one embodiment, at CALCULATE AGGREGATED STATISTIC CALCULATION DATA OPERATION 309, the statistics calculator module 122 calculates aggregated statistic calculation data representing at least one calculated aggregated statistic based on the aggregated statistic definition associated with the respective at least one calculation instruction of the calculation instruction data. The aggregated statistic calculation data is calculated over the pipeline data 127 associated with the respective at least one grouping profile definition associated with the respective at least one calculation instruction of the calculation instruction data. In one embodiment, the statistics calculator module 122 receives the set of calculations to perform and executes the instructions over the pipeline data 127. For example, if the calculation instruction data includes the aggregated statistic definition of average credit score and a grouping profile definition of users who are 25 to 35 years old and who live in San Diego or San Francisco, then the statistics calculator module 122 can search the pipeline data 127 for data corresponding to the grouping profile definition and perform the statistical calculation to derive, for example, aggregated statistic calculation data of an average credit score of 712.

In one embodiment, once the aggregated statistic calculation data is calculated by the statistics calculator module 122 at CALCULATE AGGREGATED STATISTIC CALCULATION DATA OPERATION 309, process flow proceeds to PREPARE AGGREGATED STATISTIC OUTPUT DATA OPERATION 311.

In one embodiment, at PREPARE AGGREGATED STATISTIC OUTPUT DATA OPERATION 311, the output preparer module 125 prepares aggregated statistic output data representing a prepared aggregated statistic based in part on the aggregated statistic calculation data and based in part on data privacy data representing a data privacy policy. In one embodiment, a data privacy policy requires that aggregated statistic output data must be based on data associated with a sufficient quantity of users. In one embodiment, a grouping profile may be required to include a threshold number of users. If the threshold number of users is not met, which indicates that the aggregated data may not be sufficiently anonymized in accordance with relevant data protection regulations or privacy policies, then the aggregated statistic output data is not submitted to the client. In one embodiment, in place of the aggregated statistic output data, the output preparer module 125 may replace the aggregated statistic output data with a message indicating that the prepared aggregated statistic output data may not be shown (e.g., for data privacy reasons). In one embodiment, the input interpreter module 124 modifies the grouping profile definition to broaden the count of users so that new aggregated statistic calculation data can be calculated by the statistics calculator module 122 that meets the threshold of the count of users. In one embodiment, the aggregated statistic output data is prepared with at least one data distribution rule that, for example, prevents a privacy policy from being violated. A distribution rule may define the distribution of aggregated statistic output data to clients in conformity with the privacy policy and may prevent aggregated statistic output data from being distributed to a client. In one embodiment, the aggregated statistic output data is prepared with at least one machine-learned preparation model. For example, the at least one machine-learned preparation model may be generated from feedback data of the client of the client system, and the feedback data may be associated with previous aggregated statistic output data having been previously transmitted to the client system.

In one embodiment, the output preparer module 125 receives the set of calculations from the statistics calculator module 122. In one embodiment, the output preparer module 125 uses logic to determine which calculation is appropriate or optimal to return to the client system 131. In one embodiment, the output preparer module 125 uses intelligence to determine which calculation is appropriate or optimal to return to the client system 131. In one embodiment, such intelligence may include the nature of the query request input data or the nature of the pipeline data 127 related to users received by the input interpreter module 124. In one embodiment, the output preparer module 125 enforces data privacy requirements of the aggregated statistics system. For example, the output preparer module 125 may restrict returned results if not enough users matched the grouping criteria.

In one embodiment, once the aggregated statistic output data is prepared by the output preparer module 125 at PREPARE AGGREGATED STATISTIC OUTPUT DATA OPERATION 311, process flow proceeds to TRANSMIT AGGREGATED STATISTIC OUTPUT DATA OPERATION 313.

In one embodiment, at TRANSMIT AGGREGATED STATISTIC OUTPUT DATA OPERATION 313, the client interface module 123 receives the aggregated statistic output data from the output preparer module 125 and transmits the aggregated statistic output data to the client system 131. In one embodiment, the aggregated statistic output data is transmitted to a client of the client system 131 through the results module 133 of the client system 131. In one embodiment, the results module 133 displays the aggregated statistic output data to the client. For example, the results module 133 may cause an output screen to be displayed to the client from which the client can view the aggregated statistic output data. In one embodiment, the results module 133 provides a client with aggregated statistic output data based on the modularized intelligence of the aggregated statistics system 120.

In one embodiment, the aggregated statistic output data is associated with client lifestyle change recommendation data representing a client lifestyle change recommendation. In one embodiment, the client interface module 123 is further configured to transmit the client lifestyle change recommendation data to the client system 131. In one embodiment, the results module 133 displays the client lifestyle change recommendation data to the client through a user interface. In one embodiment, the client system 131 allows the client to make a change in lifestyle based in part on the client lifestyle change recommendation data.

In one embodiment, the aggregated statistic output data is associated with procurement recommendation data representing a client procurement recommendation, for example, a recommendation associated with a purchase of a product. In one embodiment, the client interface module 123 is further configured to transmit the procurement recommendation data to the client system 131. In one embodiment, the results module 133 displays the procurement recommendation data to the client through a user interface. In one embodiment, the client system 131 allows the client to make a purchase based in part on the procurement recommendation data.

In one embodiment, once the aggregated statistics output data is transmitted by the client interface module 123 at TRANSMIT AGGREGATED STATISTIC OUTPUT DATA OPERATION 313, process flow proceeds to EXIT OPERATION 315.

In one embodiment, at EXIT OPERATION 315, the process 300 for generating aggregated statistics over sets of user data while enforcing data governance policy is exited.

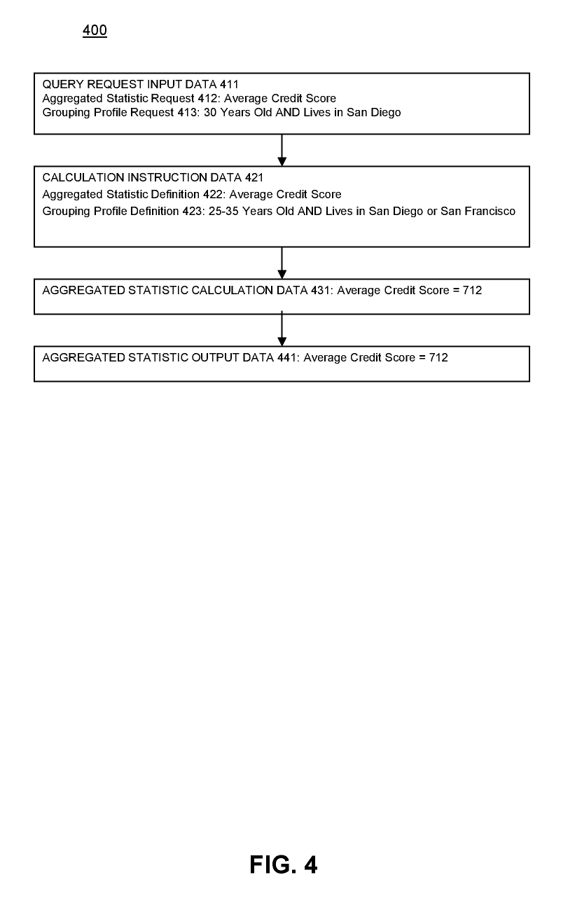

FIG. 4 is a diagram of examples 400 of portions of illustrative data for aggregated statistics generation over sets of user data while enforcing data governance policy, in accordance with various embodiments. Referring to FIGS. 1 and 4 together, the input interpreter module 124 receives query request input data 411 comprising an aggregated statistic request 412 of an average credit score and a grouping profile request 413 of a grouping of 30-year-old users and a grouping of users who live in San Diego. In this example, the input interpreter module 124 interprets the grouping profile request 413 to be broadened to include 25-to-35-year-old users and to include users who live in San Diego or San Francisco.

The statistics calculator module 122 receives calculation instruction data 421 comprising an aggregated statistic definition 422 of average credit score and a grouping profile definition 423 of 25-to-35-year-old users and a grouping of users who live in San Diego or San Francisco. The statistics calculator module 122 calculates the aggregated statistic based on the calculation instruction data 421. The output preparer module 125 receives the aggregated statistic calculation data 431 of an average credit score of 712. The output preparer module 125 determines that the aggregated statistic calculation data 431 does not violate a data governance policy. The output preparer module 125 then transmits the aggregated statistic output data 441 of an average credit score of 712.

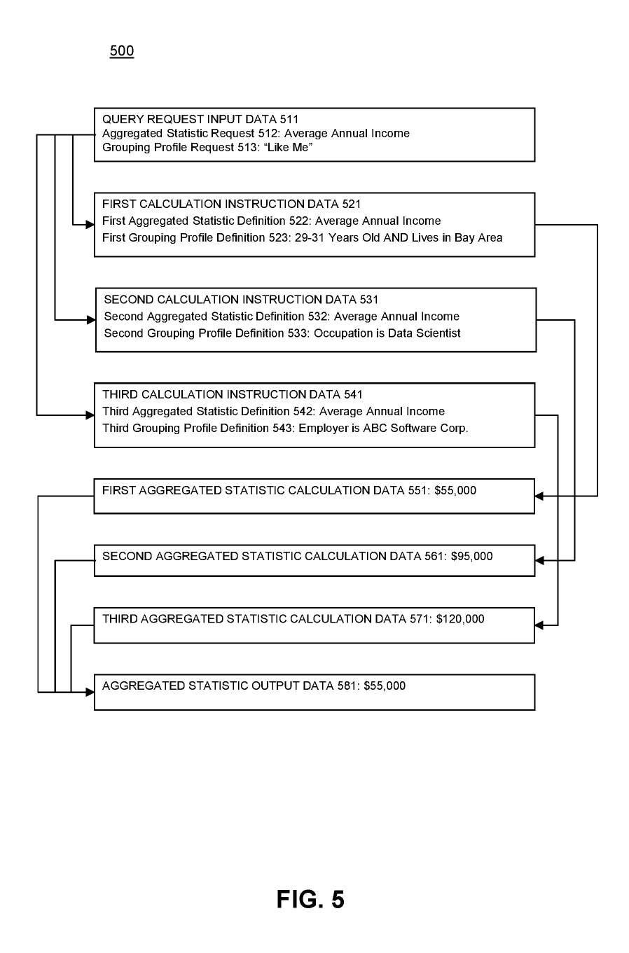

FIG. 5 is a diagram of examples 500 of portions of illustrative data for aggregated statistics generation over sets of user data while enforcing data governance policy, in accordance with various embodiments. Referring to FIGS. 1 and 5 together, the input interpreter module 124 receives query request input data 511 comprising an aggregated statistic request 512 of an average annual income and a grouping profile request 513 of a grouping of users like the client, represented by “like me.” In this example, the input interpreter module 124 interprets the query request input data 511 into three instructions that interpret “like me.” The first calculation instruction data 521 includes a first aggregated statistic definition 522 of average annual income and a first grouping profile definition 523 of 29-to-31-year-old users and users who live in the Bay Area. The second calculation instruction data 531 includes a second aggregated statistic definition 532 of average annual income and a second grouping profile definition 533 of users with an occupation of data scientist. The third calculation instruction data 541 includes a third aggregated statistic definition 542 of average annual income and a third grouping profile definition 543 of users who are employed by a company named, for example, ABC Software, Corp.

The statistics calculator module 122 receives the three instructions of the first calculation instruction data 521, the second calculation instruction data 531, and the third calculation instruction data 541. Based on the first calculation instruction data 521, the statistics calculator module 122 calculates first aggregated statistic calculation data 551 of an average annual income of $55,000. Based on the second calculation instruction data 531, the statistics calculator module 122 calculates second aggregated statistic calculation data 561 of an average annual income of $95,000. Based on the third calculation instruction data 541, the statistics calculator module 122 calculates third aggregated statistic calculation data 571 of an average annual income of $120,000.

The output preparer module 125 receives the first aggregated statistic calculation data 551, the second aggregated statistic calculation data 561, and the third aggregated statistic calculation data 571. In this example, the output preparer module 125 determines that the third aggregated statistic calculation data 571 is not in compliance with data governance policy because the count of users is too small based on the number of employees at ABC Software, Corp. Further in this example, the output preparer module 125 determines that the first aggregated statistic calculation data 551 of an average annual income of $55,000 will be more favorable to the requesting client than the second aggregated statistic calculation data 561 of an average annual income of $95,000. This may be, for example, because the client's annual income is $60,000, and the client may be discouraged seeing an average annual income that is $35,000 more than the client earns, compared to an average annual income that is $5,000 less than the client earns. Accordingly, in this example, the output preparer module 125 prepares the aggregated statistic output data 581 to be an average annual income of $55,000, which corresponds to the intelligently chosen first aggregated statistic calculation data 551.

The generation of aggregated statistics over sets of user data while enforcing data governance policy is a technical solution to a long standing technical problem and is not an abstract idea for at least a few reasons. First, generating aggregated statistics over sets of user data while enforcing data governance policy is not an abstract idea because it is not merely an idea itself (e.g., can be performed mentally or using pen and paper). In contrast, the embodiments disclosed herein utilize and process special data from data management sources and multiple users, special algorithms including machine learning algorithms, and customized user displays that are essential for the creation of responses to client queries that enable a client to assess a financial or other position in comparison to other users. In addition, using the disclosed embodiments, a data management system is provided that consistently, accurately, and efficiently provides a client of the data management system with an aggregated statistic that yields significant improvement to the technical fields of data processing, data management, electronic financial management, data transmission, and user experience, according to one embodiment. The present disclosure adds significantly to the field of data management services because the disclosed service provider system: increases the likelihood that a client will continue to utilize the data management system due to being able to discover actionable insights that were previously only available to personnel of the data management service provider; decreases the analytics that such personnel must perform on user data to prevent inadvertent public publication of non-aggregated data; and decreases the processor consumption associated with analytics through guidance from machine-learned algorithms that provide targeted queries with limited data sets compared to the processor consumption of unguided, ad hoc data analytics.

Second, generating aggregated statistics over sets of user data while enforcing data governance policy is not an abstract idea because it is not a fundamental economic practice (e.g., is not merely creating a contractual relationship, hedging, mitigating a settlement risk, etc.). In contrast, the disclosed embodiments provide for aggregated statistics that are essential for the creation of responses to client queries that enable a client to assess a financial or other position in comparison to other users. In addition, embodiments of the present disclosure allow for reduced use of processor cycles, memory, bandwidth, and power consumption associated with the efforts of clients to discover actionable insights from user data exposed to clients through machine-learned modules that provide aggregated statistics tailored to the clients, compared to unguided, ad hoc data analytics, and provide a solution to Internet and data processing problems. Consequently, computing and communication systems implementing or providing the embodiments of the present disclosure are transformed into more operationally efficient devices and systems.

Third, generating aggregated statistics over sets of user data while enforcing data governance policy is not an abstract idea because it is not a method of organizing human activity (e.g., managing a game of bingo), but is rather, in one embodiment, a tool for enabling a client to assess a client's financial or other position through the creation of query responses. In addition, using the disclosed embodiments, a data management system is provided that significantly improves the field of data management systems by reducing the amount of time it takes for a client to determine a course of action based on actionable insights from aggregated statistics, according to one embodiment. Therefore, both human and non-human resources are utilized more efficiently.

Fourth, although mathematics may be used in generating aggregated statistics over sets of user data while enforcing data governance policy, the disclosed and claimed method and system of generating aggregated statistics over sets of user data while enforcing data governance policy is not an abstract idea because the method and system is not simply a mathematical relationship/formula. In contrast, the disclosed embodiments provide for the customized generation of aggregated statistics that are essential for the creation of query responses that enable a client to assess a client's financial or other position in comparison to other users. In addition, using the disclosed embodiments, a data management system is provided that increases loyalty to the data management system. This results in repeat customers, efficient data management services, and reduced abandonment of use of the data management system, according to one embodiment.

As discussed in more detail above, using the above embodiments, with little or no modification and/or input, there is considerable flexibility, adaptability, and opportunity for customization to meet the specific needs of various parties under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, and/or protocols. Further, the system and/or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic and/or algorithm-like descriptions and representations are the means used by those of skill in the art to most effectively and efficiently convey the substance of their work to others of skill in the art. These operations, while described functionally or logically, are understood to be implemented by computer programs and/or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating,” “accessing,” “adding,” “aggregating,” “alerting,” “applying,” “analyzing,” “associating,” “calculating,” “capturing,” “categorizing,” “classifying,” “comparing,” “creating,” “defining,” “detecting,” “determining,” “distributing,” “eliminating,” “encrypting,” “extracting,” “filtering,” “forwarding,” “generating,” “identifying,” “implementing,” “informing,” “monitoring,” “obtaining,” “posting,” “processing,” “providing,” “receiving,” “requesting,” “saving,” “sending,” “storing,” “substituting,” “transferring,” “transforming,” “transmitting,” “using,” etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general-purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general-purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar and/or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the figures, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A system for aggregated statistics generation over sets of user data while enforcing data governance policy for use with a data management service, comprising:
a data pipeline module configured to:
receive pipeline data from a plurality of data warehouses;
an input interpreter module configured to:
receive from a client system query request input data representing a query request of a client of the client system, wherein the query request comprises an aggregated statistic request and a grouping profile request, and
interpret the query request input data into calculation instruction data representing at least one calculation instruction, wherein the at least one calculation instruction comprises an aggregated statistic definition interpreted from the aggregated statistic request and at least one grouping profile definition interpreted from the grouping profile request based in part on the pipeline data associated with the client of the client system;
a statistics calculator module configured to:
receive the calculation instruction data from the input interpreter module, and
calculate aggregated statistic calculation data representing at least one calculated aggregated statistic based on the pipeline data, wherein the aggregated statistic calculation data is determined according to:
the aggregated statistic definition associated with the respective at least one calculation instruction of the calculation instruction data, and
the respective at least one grouping profile definition associated with the respective at least one calculation instruction of the calculation instruction data; and
an output preparer module configured to:
receive the aggregated statistic calculation data from the statistics calculator module,
prepare aggregated statistic output data representing a prepared aggregated statistic based in part on the aggregated statistic calculation data and based in part on data privacy data representing a data privacy policy, and
transmit the aggregated statistic output data to the client system.

2. The system of claim 1, wherein the data pipeline module is further configured to identify reliable data from the pipeline data by identifying, using data fusion, a reliable data warehouse of the plurality of data warehouses for a specific type of data.

3. The system of claim 1, wherein the at least one calculation instruction is interpreted with at least one machine-learned interpretation model generated from feedback data associated with previously generated aggregated statistic output data.

4. The system of claim 3, wherein the at least one machine-learned interpretation model adjusts the at least one grouping profile definition.

5. The system of claim 1, wherein the prepared aggregated statistic is prepared with at least one data distribution rule, the at least one data distribution rule preventing a privacy policy from being violated and defining the distribution of aggregated statistic output data to the client in conformity with the privacy policy.

6. The system of claim 1, wherein the prepared aggregated statistic is prepared with at least one machine-learned preparation model generated from feedback data associated with previously generated aggregated statistic output data.

7. The system of claim 6, wherein the at least one machine-learned preparation model uses information about the client of the client system to identify which calculation result of a plurality of calculation results is to be transmitted to the client system.

8. The system of claim 1, wherein the output preparer module is further configured to:
determine whether the pipeline data associated with the respective at least one grouping profile definition meets a determined threshold of a count of users, and
upon determining that the determined threshold is not met, take one or more actions to modify the aggregated statistic output data.

9. The system of claim 8, wherein the one or more actions comprises modifying the aggregated statistic output data to represent a message to the client that a prepared aggregated statistic cannot be transmitted to the client system.

10. The system of claim 8, wherein the one or more actions comprises recalculating the aggregated statistic output data based on a broadened definition of the at least one grouping profile definition.

11. The system of claim 1, wherein the aggregated statistic output data is associated with client lifestyle change recommendation data representing a client lifestyle change recommendation, wherein the client interface module is further configured to transmit the client lifestyle change recommendation data to the client system.

12. The system of claim 1, wherein the aggregated statistic output data is associated with procurement recommendation data representing a client procurement recommendation associated with a purchase of a product, wherein the client interface module is further configured to transmit the procurement recommendation data to the client system.

13. A method for aggregated statistics generation over sets of user data while enforcing data governance policy for use with a data management service, comprising:
receiving pipeline data from at least one data warehouse;
receiving query request input data representing a query request from a client system, the query request comprising an aggregated statistic request and a grouping profile request;
interpreting the query request input data into calculation instruction data representing at least one calculation instruction, the at least one calculation instruction comprising an aggregated statistic definition interpreted from the aggregated statistic request and at least one grouping profile definition interpreted from the grouping profile request;
calculating aggregated statistic calculation data representing at least one calculated aggregated statistic based on the pipeline data, the aggregated statistic calculation data is determined according to the aggregated statistic definition associated with the respective at least one calculation instruction of the calculation instruction data, and the respective at least one grouping profile definition associated with the respective at least one calculation instruction of the calculation instruction data;
preparing aggregated statistic output data representing a prepared aggregated statistic based in part on the aggregated statistic calculation data and based in part on data privacy data representing a data privacy policy; and
transmitting the aggregated statistic output data to the client system.

14. The method of claim 13, wherein after receiving the pipeline data from the at least one data warehouse, identifying, using data fusion, a reliable data warehouse of the at least one data warehouse for a specific type of data.

15. The method of claim 13, wherein before receiving the query request input data representing the query request from the client system, security requirements associated with the client system are enforced.

16. The method of claim 13, wherein the at least one grouping profile definition is interpreted from the grouping profile request based in part on the pipeline data associated with a client of the client system.

17. The method of claim 13, wherein the at least one calculation instruction is interpreted with at least one machine-learned interpretation model generated from feedback data associated with previously generated aggregated statistic output data.

18. The method of claim 17, wherein the at least one machine-learned interpretation model adjusts the at least one grouping profile definition.

19. The method of claim 13, wherein the prepared aggregated statistic is prepared with at least one data distribution rule, the at least one data distribution rule associated with preventing a privacy policy from being violated and defining the distribution of aggregated statistic output data to the client in conformity with the privacy policy.

20. The method of claim 13, wherein the prepared aggregated statistic is prepared with at least one machine-learned preparation model generated from feedback data associated with previously generated aggregated statistic output data.

21. The method of claim 20, wherein the at least one machine-learned preparation model uses information about a client of the client system to identify which calculation result of a plurality of calculation results is to be transmitted to the client system.

22. The method of claim 13, wherein preparing the aggregated statistic output data representing a prepared aggregated statistic based in part on data privacy data representing a data privacy policy comprises determining whether the pipeline data associated with the respective at least one grouping profile definition meets a determined threshold of a count of users, and upon determining that the determined threshold is not met, taking one or more actions to modify the aggregated statistic output data.

23. The method of claim 22, wherein the one or more actions comprises modifying the aggregated statistic output data to represent a message to a client of the client system that a prepared aggregated statistic cannot be transmitted to the client system.

24. The method of claim 22, wherein the one or more actions comprises recalculating the aggregated statistic output data based on a broadened definition of the at least one grouping profile definition.

25. The method of claim 13, wherein the aggregated statistic output data is associated with client lifestyle change recommendation data representing a client lifestyle change recommendation, wherein the client lifestyle change recommendation data is transmitted to the client system.

26. The method of claim 13, wherein the aggregated statistic output data is associated with procurement recommendation data representing a client procurement recommendation associated with a purchase of a product, wherein the client interface module is further configured to transmit the procurement recommendation data to the client system.

27. A system for aggregated statistics generation over sets of user data while enforcing data governance policy for use with a data management service, comprising:
at least one processor; and
at least one memory coupled to the at least one processor, the at least one memory having stored therein instructions which when executed by any set of the at least one processor, perform a process for use with the transaction management service, the process including:
receiving pipeline data from at least one data warehouse;
receiving query request input data representing a query request from a client system, the query request comprising an aggregated statistic request and a grouping profile request;
interpreting the query request input data into calculation instruction data representing at least one calculation instruction, the at least one calculation instruction comprising an aggregated statistic definition interpreted from the aggregated statistic request and at least one grouping profile definition interpreted from the grouping profile request;
calculating aggregated statistic calculation data representing at least one calculated aggregated statistic based on the pipeline data, the aggregated statistic calculation data is determined according to the aggregated statistic definition associated with the respective at least one calculation instruction of the calculation instruction data, and the respective at least one grouping profile definition associated with the respective at least one calculation instruction of the calculation instruction data;
preparing aggregated statistic output data representing a prepared aggregated statistic based in part on the aggregated statistic calculation data and based in part on data privacy data representing a data privacy policy; and
transmitting the aggregated statistic output data to the client system.

28. The system of claim 27, wherein after receiving the pipeline data from the at least one data warehouse, identifying, using data fusion, a reliable data warehouse of the at least one data warehouse for a specific type of data.

29. The system of claim 27, wherein before receiving the query request input data representing the query request from the client system, security requirements associated with the client system are enforced.

30. The system of claim 27, wherein the at least one grouping profile definition is interpreted from the grouping profile request based in part on the pipeline data associated with a client of the client system.

31. The system of claim 27, wherein the at least one calculation instruction is interpreted with at least one machine-learned interpretation model generated from feedback data associated with previously generated aggregated statistic output data.

32. The system of claim 31, wherein the at least one machine-learned interpretation model adjusts the at least one grouping profile definition.

33. The system of claim 27, wherein the prepared aggregated statistic is prepared with at least one data distribution rule, the at least one data distribution rule associated with preventing a privacy policy from being violated and defining the distribution of aggregated statistic output data to the client in conformity with the privacy policy.

34. The system of claim 27, wherein the prepared aggregated statistic is prepared with at least one machine-learned preparation model generated from feedback data associated with previously generated aggregated statistic output data.

35. The system of claim 34, wherein the at least one machine-learned preparation model uses information about a client of the client system to identify which calculation result of a plurality of calculation results is to be transmitted to the client system.

36. The system of claim 27, wherein preparing the aggregated statistic output data representing a prepared aggregated statistic based in part on data privacy data representing a data privacy policy comprises determining whether the pipeline data associated with the respective at least one grouping profile definition meets a determined threshold of a count of users, and upon determining that the determined threshold is not met, taking one or more actions to modify the aggregated statistic output data.

37. The system of claim 36, wherein the one or more actions comprises modifying the aggregated statistic output data to represent a message to a client of the client system that a prepared aggregated statistic cannot be transmitted to the client system.

38. The system of claim 36, wherein the one or more actions comprises recalculating the aggregated statistic output data based on a broadened definition of the at least one grouping profile definition.

39. The system of claim 27, wherein the aggregated statistic output data is associated with client lifestyle change recommendation data representing a client lifestyle change recommendation, wherein the client lifestyle change recommendation data is transmitted to the client system.

40. The system of claim 27, wherein the aggregated statistic output data is associated with procurement recommendation data representing a client procurement recommendation associated with a purchase of a product, wherein the client interface module is further configured to transmit the procurement recommendation data to the client system.

41. A system for aggregated statistics generation over sets of user data while enforcing data governance policy for use with a data management service, comprising:
at least one processor; and
at least one memory coupled to the at least one processor, the at least one memory having stored therein instructions which when executed by any set of the at least one processor, perform a process for use with the transaction management service, the process including:
a data pipeline module configured to:
receive pipeline data from at least one data warehouse;
an input interpreter module configured to:
receive query request input data representing a query request from a client system, wherein the query request comprises an aggregated statistic request and a grouping profile request, and
interpret the query request input data into calculation instruction data representing at least one calculation instruction, wherein the at least one calculation instruction comprises an aggregated statistic definition interpreted from the aggregated statistic request and at least one grouping profile definition interpreted from the grouping profile request;
a statistics calculator module configured to:
calculate aggregated statistic calculation data representing at least one calculated aggregated statistic based on the pipeline data, wherein the aggregated statistic calculation data is determined according to:
the aggregated statistic definition associated with the respective at least one calculation instruction of the calculation instruction data, and
the respective at least one grouping profile definition associated with the respective at least one calculation instruction of the calculation instruction data; and
an output preparer module configured to:
prepare aggregated statistic output data representing a prepared aggregated statistic based in part on the aggregated statistic calculation data and based in part on data privacy data representing a data privacy policy, and
transmit the aggregated statistic output data to the client system.

42. The system of claim 41, wherein the data pipeline module is further configured to identify reliable data from the pipeline data by identifying, using data fusion, a reliable data warehouse of the at least one data warehouse for a specific type of data.

43. The system of claim 41, further comprising:
a client interface module configured to enforce security requirements associated with the client system.

44. The system of claim 41, wherein the input interpreter module is further configured to interpret the at least one calculation instruction with at least one machine-learned interpretation model generated from feedback data associated with previously generated aggregated statistic output data.

45. The system of claim 44, wherein the at least one machine-learned interpretation model adjusts the at least one grouping profile definition.

46. The system of claim 41, wherein the prepared aggregated statistic is prepared with at least one data distribution rule, the at least one data distribution rule preventing a privacy policy from being violated and defining the distribution of aggregated statistic output data to the client in conformity with the privacy policy.

47. The system of claim 41, wherein the prepared aggregated statistic is prepared with at least one machine-learned preparation model generated from feedback data associated with previously generated aggregated statistic output data.

48. The system of claim 47, wherein the at least one machine-learned preparation model uses information about a client of the client system to identify which calculation result of a plurality of calculation results is to be transmitted to the client system.

49. The system of claim 41, wherein the output preparer module is further configured to:
determine whether the pipeline data associated with the respective at least one grouping profile definition meets a determined threshold of a count of users, and
upon determining that the determined threshold is not met, take one or more actions to modify the aggregated statistic output data.

50. The system of claim 49, wherein the one or more actions comprises modifying the aggregated statistic output data to represent a message to a client of the client system that a prepared aggregated statistic cannot be transmitted to the client system.

51. The system of claim 49, wherein the one or more actions comprises recalculating the aggregated statistic output data based on a broadened definition of the at least one grouping profile definition.

52. The system of claim 41, wherein the aggregated statistic output data is associated with client lifestyle change recommendation data representing a client lifestyle change recommendation, wherein the client interface module is further configured to transmit the client lifestyle change recommendation data to the client system.

53. The system of claim 41, wherein the aggregated statistic output data is associated with procurement recommendation data representing a client procurement recommendation associated with a purchase of a product, wherein the client interface module is further configured to transmit the procurement recommendation data to the client system.
